(19) United States
(12) Patent Application Publication
(10) Pub. No.: US 2018/0075462 A1
(43) Pub. Date: Mar. 15, 2018

(54) SYSTEMS AND METHODS FOR ANALYZING REMOTELY LOCATED FACILITIES

(71) Applicant: Wal-Mart Stores, Inc., Bentonville, AR (US)

(72) Inventors: Nicholaus Adam Jones, Fayetteville, AR (US); Robert James Taylor, Rogers, AR (US); Aaron James Vasgaard, Fayetteville, AR (US); Matthew Allen Jones, Bentonville, AR (US)

(21) Appl. No.: 15/701,737

(22) Filed: Sep. 12, 2017

Related U.S. Application Data
(60) Provisional application No. 62/393,808, filed on Sep. 13, 2016.

(51) Int. Cl. G06Q 30/02; G06Q 10/08

(52) U.S. Cl. CPC G06Q 30/0201; G06Q 10/087

(57) ABSTRACT

Methods, systems, and machine readable medium are provided for analyzing remotely located facilities based on sensed data. Exemplary embodiments include sensing data by one or more sensors located at or near a first facility to determine customer traffic and adding the sensed data to a set of stored data associated with the first facility. Customer demographics of the first facility are determined based on the sensed data, and transaction data for the first facility is received from one or more computing systems at the first facility. A second facility is identified that has customer demographics with a pre-defined degree of similarity to the customer demographics of the first facility. Transaction data of the second facility is analyzed with respect to the transaction data of the first facility and an improvement or change in item assortment at the first facility is determined based on the analysis.

### RELATED APPLICATION

This application claims the benefit of, and priority to, U.S. Provisional Patent Application No. 62/393,808, entitled “Systems and Methods for Analyzing Remotely Located Facilities, filed Sep. 13, 2016, the contents of which are incorporated herein in their entirety.

### BACKGROUND

Sensors are often used to detect various data and information. Sensors can collect data using a variety of different mechanisms. For example, video, acoustic, mechanical and other forms of sensors may be used to collect data.

### SUMMARY

In one embodiment, a method for analyzing remotely located facilities based on sensed data includes sensing data by one or more sensors located at or near a first facility, where the sensed data indicates customer traffic at the first facility. The method further includes adding the sensed data to a set of stored data associated with the first facility and determining customer demographics of the first facility based on the sensed data. Transaction data for the first facility is received from one or more computing systems at the first facility and a second facility is identified that has customer demographics with a pre-defined degree of similarity to the customer demographics of the first facility. The method further analyzes transaction data of the second facility with respect to the transaction data of the first facility and an improvement or change in item assortment at the first facility is determined based on the analysis.

In another embodiment, a system for analyzing remotely located facilities based on sensed data includes one or more sensors configured to sense data indicative of customer traffic, a memory, and a processor in a processing device that is in communication with the memory. The memory stores instructions that when executed by the processor cause the system to receive sensed data from the one or more sensors located at or near a first facility and add the sensed data to a set of stored data associated with the first facility. The processing device then determines customer demographics of the first facility based on the sensed data and receives transaction data for the first facility from one or more computing systems at the first facility. The instructions when executed by the processor further cause the system to identify a second facility having customer demographics with a pre-defined degree of similarity to the customer demographics of the first facility and analyze transaction data of the second facility with respect to the transaction data of the first facility. Additionally the instructions when executed by the processor cause the system to determine an improvement or change in item assortment at the first facility based on the analysis.

In yet another embodiment, a non-transitory computer readable medium is provided that stores instructions that when executed by a processor causes the processor to implement a method for analyzing remotely located facilities based on sensed data. The method includes sensing data by one or more sensors located at or near a first facility. The sensed data indicates customer traffic. The implemented method further includes adding the sensed data to a set of stored data associated with the first facility and determining customer demographics of the first facility based on the sensed data. Transaction data for the first facility is received from one or more computing systems at the first facility, and a second facility is identified that has customer demographics with a pre-defined degree of similarity to the customer demographics of the first facility. Additionally the implemented method analyzes transaction data of the second facility with respect to the transaction data of the first facility and an improvement or change in item assortment at the first facility is determined based on the analysis.

### BRIEF DESCRIPTION OF THE DRAWINGS

The accompanying figures, which are incorporated in and constitute a part of this specification, illustrate one or more embodiments of the present invention and, together with the description, help to explain the present invention. The embodiments are illustrated by way of example and should not be construed to limit the present invention. In the figures:

FIG. 1 is a block diagram showing an exemplary analysis system for analyzing remotely located facilities based sensed data, according to an example embodiment;

FIG. 2 is a flowchart illustrating an exemplary method for analyzing remotely located facilities based on sensed data, according to an example embodiment;

FIG. 3 is a diagram of an exemplary network environment suitable for a distributed implementation of exemplary embodiments; and

FIG. 4 is a block diagram of an exemplary computing device that may be used to implement exemplary embodiments described herein.

### DETAILED DESCRIPTION

Systems, method and computer readable medium are described for analyzing remotely located facilities based on sensed data. Exemplary embodiments of the present invention include one or more sensors to acquire data indicating customer traffic at a first facility. Customer demographics information is determined from the acquired data. A second facility is identified as having similar customer demographics as the first facility and transaction data for the first facility may be compared with the transaction data at the second facility to determine improvements or change in item assortment at the first facility. In this manner, rather than comparing geographically similar facilities or closely located facilities for analysis, the present invention identifies a remotely located facility that has a similar customer demographics to provide valuable analysis with respect to products offered at a first facility.

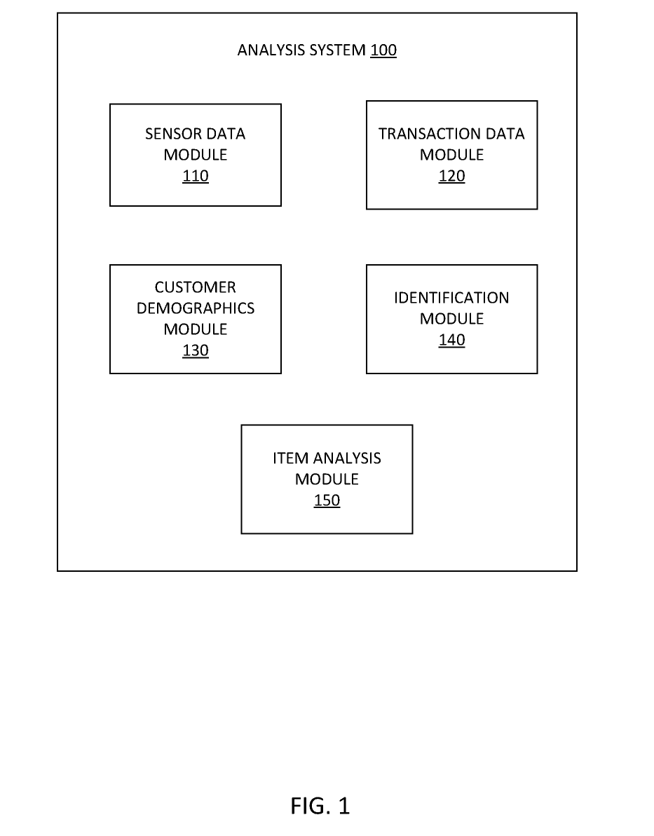

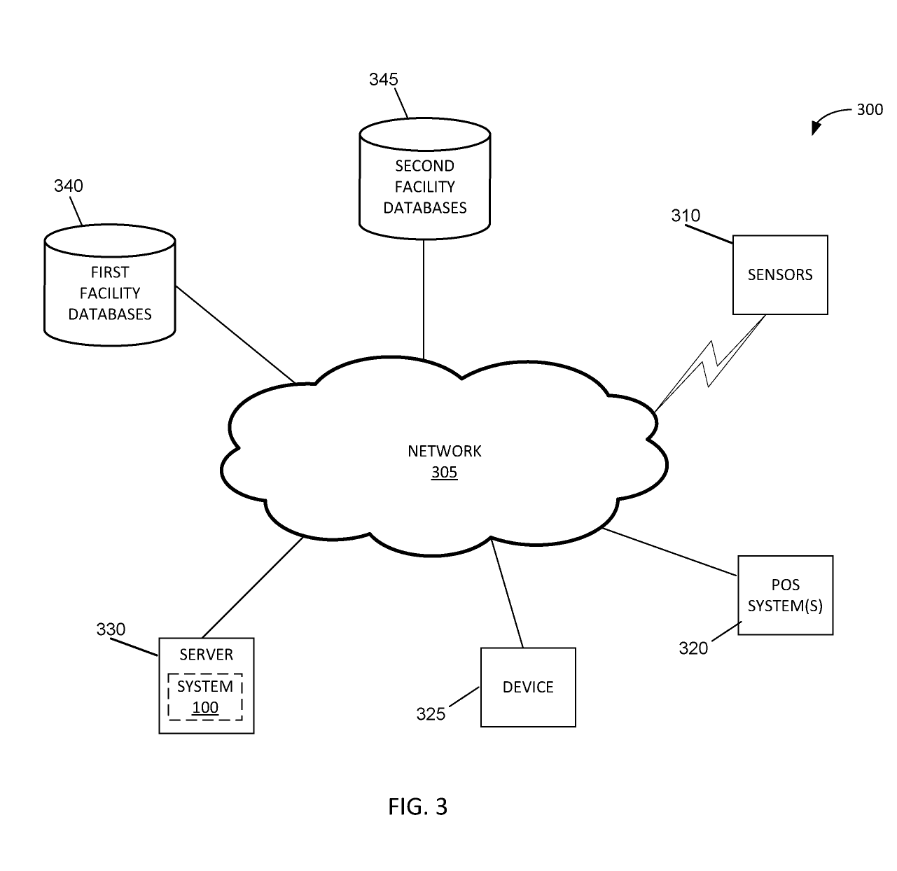

FIG. 1 is a block diagram showing a sensor system 100 in terms of modules for analyzing remotely located facilities based on sensed data, according to an example embodiment. The one or more of the modules may be implemented in server 330 shown in FIG. 3. The modules include a sensor data module 110, a transaction data module 120, a customer demographics module 130, an identification module 140, and an item analysis module 150. The modules may include various circuits, circuitry and one or more software components, programs, applications, or other units of code base or instructions configured to be executed by one or more processors (e.g., included in the server 330 shown in FIG. 3). Although modules 110, 120, 130, 140, 150 are shown as distinct modules in FIG. 1, it should be understood that modules 110, 120, 130, 140, and 150 may be implemented as fewer or more modules than illustrated. It should be understood that in some embodiments any of modules 110, 120, 130, 140, and 150 may communicate with one or more components included in exemplary embodiments (e.g., sensors 310, POS system(s) 320, device 325, server 330, or database(s) 340, 345 of system 300 shown in FIG. 3).

The sensor data module 110 may be configured to receive and manage data acquired or sensed by sensors (e.g., sensors 310), and maintain and control the various sensors. In one embodiment, the sensed data indicates customer traffic at a facility. The sensors 310 may be part of a sensor system to sense data indicating customer traffic. A number of exemplary sensor systems are discussed herein but it should be appreciated that the sensor systems discussed are illustrative examples and other systems not specifically discussed that are able to determine customer traffic and other data should also be considered to be within the scope of the present invention.

One such exemplary sensor system includes a shopping cart corral system that enables estimation of customer traffic within a facility. In this embodiment, based on an estimated shopping cart count within a shopping cart corral or enclosure, and the number of shopping carts entering and/or exiting the retail environment, the number of customers within the facility can be estimated. The example shopping cart corral system may estimate a quantity of shopping carts disposed in the shopping cart corral based on at least a property of a reflected radio-frequency signal from the carts.

Another exemplary sensor system includes disposing emission sensors in a parking lot of a facility to measure vehicle emissions or vehicle exhaust output. The emission sensors may be disposed in parking locations where exhaust is admitted, along the driving lanes near the facility, at the auto center service department, at the garden center loading area, under awnings, at a pharmacy drive-through, at lights in the parking lot, and/or through dedicated monitoring stations. The sensed data collected over time via the emissions sensors may be used to determine a vehicle type and an approximate age of the vehicle. In some embodiments, this exemplary sensor system may also determine when a vehicle enters and when a vehicle leaves. This exemplary sensor system may also include acoustic sensors to determine RPM range of a vehicle. Using the sensed data, this exemplary sensor system may determine customer traffic in the store, and also a change in load for a vehicle (based on passengers and products in the vehicle).

Another exemplary sensor system includes disposing acoustic sensors in the parking lot to sense sounds near a vehicle. The sensed data may be used to determine customer demographics. The sensed data may be compared with other data (such as, transaction data, customer information, etc.) to determine demographics of the customers that shop at the facility.

Another exemplary sensor system includes disposing weight sensors in each parking space in a parking lot of a facility. The sensor system may sense an initial weight of a vehicle entering a parking space, and then sense an empty vehicle weight (after the passengers have exited the vehicle) to calculate the weight of the passengers in the vehicle. Typically passengers do not exit a vehicle at the same time, and the fluctuations in the weight of vehicle can additionally be used to determine the number of passengers leaving the vehicle. Using an average weight of a person for persons who reside near the facility location, the sensor system may determine the number of passengers based on the calculated weight of the passengers. The sensor system then may also determine a final weight of the vehicle after the passengers have returned to the vehicle and have loaded their purchased items. The sensor system may determine the weight of the items purchased based on the initial weight of the vehicle and the final weight of the vehicle. The sensed data relating to weight of the vehicle can be used to determine customer traffic at a facility and customer demographics at a facility.

Yet another exemplary sensor system includes sensors that measure the entry and exit suspension loads of vehicles entering a facility area. The sensed data allows for monitoring of consumer traffic at the facility, including the ability to determine the duration of customer visits, whether items were purchased, and an estimated weight of the purchased items by analyzing a vehicle suspension. Based on a difference in the exit and entry suspension loads, a determination can be made whether items were purchased by the customer.

Another exemplary sensor system includes disposing an image capturing device over floor mats in a facility to detect deformations or depressions in the floor mats. The deformations or depressions in the floor mats may be analyzed using video analytics or machine vision to estimate customer traffic at the facility. This sensor system may determine the objects or persons which caused the depression, and a weight of the object or person. The deformable surface of the floor mat may be formed with a viscoelastic material that retains the localized depression for a period of time. In response to the floor mat receiving pressure from a foot, the floor mat may deform to the shape of the foot for a time period. In response to the floor mat receiving pressure from a wheel of a cart, the floor mat may deform to the shape of the outer circumference of the wheel for a time period. The sensor system may be configured to discriminate between different deformations based on a size and shape of the different deformations.

Another exemplary sensor system includes estimating crowd traffic in a facility by detecting debris on floor mats. The sensor system may include floor mats disposed in a facility to collect debris from objects passing over the floor mats, and image capturing devices may capture images of the debris on the floor mat. The sensor system may further detect and estimate the amount of objects causing the debris on the floor mat, and may estimate the amount of objects entering and exiting the facility based on the quantity of objects passing over the floor mats.

Yet another exemplary sensor system includes an air curtain disposed at an entry/exit of the facility. The air curtain may include a rotatable airfoil that is located downstream of the air flow source. The airfoil may include an RF reflective material that can reflect specific amounts of RF energy while rotating at specific speeds. If a person or object passes through the air curtain, the disruption of the air curtain changes the amount of air flowing across the doorway and also change the speed of rotation of the airfoil. Because the reflective airfoil reflects different amounts of RF energy at different speeds, an RF sensor may detect when objects pass through the air curtain by detecting changes in the amount of RF energy reflected by the rotating airfoil. An amount of RF energy may be directed toward the reflective airfoil and an RF sensor measures the amount of energy reflected by the airfoil. The sensor system may further include a motion detection system that may monitor reflections from the airfoil for a specific period of time and compute the number of persons passing through the air curtain during that period of time based on changes in reflections from the airfoil. This sensor system may be located at each entrance to facility and the sensed data may be used to determine customer traffic data.

The transaction data module 120 may be configured to receive and manage transaction data from POS systems (e.g., POS system(s) 320) related to transactions occurring at the POS systems. The transaction data may include data related to items purchased, item price, timestamp for the transaction, and the like. The transaction data module 120 may facilitate storing of the transaction data for the first facility in the first facility databases 340.

The customer demographics module 130 may be configured to analyze the sensed data to determine customer demographics data for a facility. The customer demographics module 130 may facilitate storing of the customer demographics data for the first facility in the first facility database 340. The customer demographics data may include data related to a type of customer (e.g., individual or family), customer shopping habits, time of shopping, time of year of shopping, and the like. The customer demographic data may be analyzed to indicate a number of customers at the facility during certain time periods.

The identification module 140 may be configured to identify a second facility with a pre-defined degree of similarity to the first facility with respect to customer demographics data. The identification module 140 may analyze the customer demographics data for the first facility and customer demographics data for the second facility. In one embodiment, the identification module 140 may also analyze the transaction data for the first facility, store demographics data for the first facility, the transaction data for the second facility, and/or store demographics data for the second facility. The identification module 140 may retrieve data from the first facility databases 340 and the second facility databases 345.

The item analysis module 150 may be configured to analyze transaction data of the first facility and transaction data of the second facility to determine an improvement or change in item assortment at the first facility. The item analysis module 150 may retrieve data from the first facility databases 340 and the second facility databases 345. The item analysis module 150 may generate a report of the analysis and store it in the first facility databases 340 or transmit it to a computing system or device of the first facility.

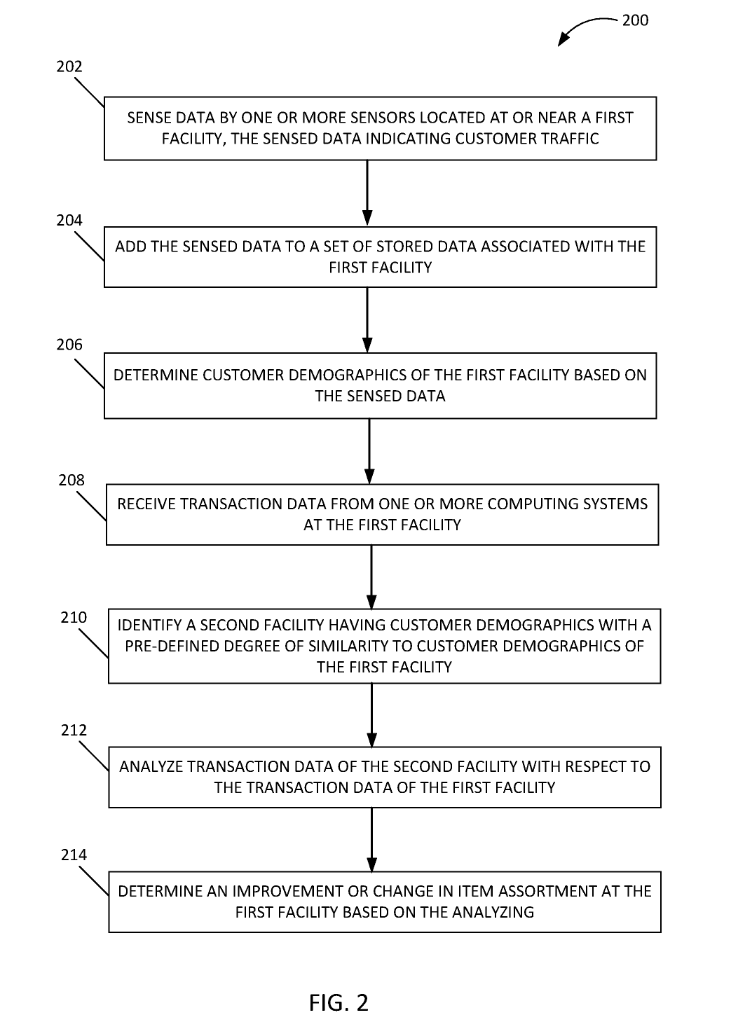

FIG. 2 is a flowchart illustrating an exemplary method 200 for analyzing remotely located facilities based on sensed data, according to an example embodiment. The method 200 may be performed using one or more modules of the analysis system 100 described above.

At step 202, the sensor data module 110 senses data by a sensor (e.g., sensors 310) located at or near a first facility, where the sensed data indicates customer traffic. The sensors 310 may be part of a sensor system configured to sense customer traffic data, that is, number of customers entering and/or exiting the facility or present at the facility. The customer traffic data may include a timestamp for the sensed data. For example, in one embodiment, the sensors 310 at the first facility include foot sensors disposed at an entrance of the first facility. The foot sensors may be configured to sense a number of footsteps entering the store, where the number of footsteps correlates to the customer traffic at the first facility. In another embodiment, the sensors 310 at the first facility include weight sensors disposed in a parking lot of the first facility. The weight sensors may be configured to sense a weight of a vehicle in the parking lot to determine a number of passengers in the vehicle, where the number of passengers correlates to the customer traffic at the first facility. In yet another embodiment, the sensors 310 at the first facility include acoustic sensors disposed at a shopping cart or shopping basket. The acoustic sensors may be configured to detect sounds indicative of a number of footsteps near the shopping cart or shopping basket, where the number of footsteps correlates to the customer traffic at the first facility. As discussed previously, the use of other sensor types to acquire demographic data for customers at the first facility is also within the scope of the present invention.

At step 204, the sensor data module 110 adds the sensed data to a set of stored data associated with the first facility. The sensed data may be stored in the first facility databases 340 with a timestamp.

At step 206, the customer demographics module 130 determines customer demographics of the first facility based on the sensed data. The customer demographics module 130 may retrieve the sensed data from the first facility databases 340.

Determining the customer demographics may include determining a classification of a customer as an individual customer or a family customer. An individual customer may be a person who shops at the facility individually (that is, by himself or herself). A family customer may be a person who shops at the facility with his or her family members (such as spouse, partner, children, etc.) In other embodiments, an individual customer may be a person who shops for an individual, and a family customer may be a person who shops for a family.

Determining of the customer demographics may also be based on a timestamp associated with the sensed data. For example, the customer demographics may be determined based on the time of day the data was sensed, where individual customers in the early hours may be classified as working people shopping before work, and individual customers after 5 pm in the evening may be classified as working people shopping after work. Similarly, a family customer shopping on a weekend may be classified as a customer with children who attend school during the week. As another example, an individual customer shopping during the week between 8 am and 5 pm may be classified as a stay-at-home individual (or non-working individual). Additionally, a customer may be classified based on the amount of time he or she spends in the facility. For example, a customer who spends more than an hour in the facility may be classified as a family customer. Whereas, a customer who spends less than an hour in the facility may be classified as an individual customer.

The customer demographics may also be determined based on the time of year the data was sensed. For example, a family customer shopping during a week in the Summer may be classified as a customer with children who are out of school during the Summer.

Additionally, the customer demographics module 130 may also determine whether a customer is using a shopping basket or a shopping cart based on the sensed data. This determination may be stored in the database as customer demographics data.

At step 208, the transaction data module 120 receives transaction data for the first facility from one or more computing systems (e.g., POS system(s) 320) at the first facility. In one embodiment, the transaction data module 120 may retrieve the transaction data from the first facility databases 340. The transaction data may include data related to items purchased/sold, a timestamp for the transaction, a transaction amount, a price for an item, and the like.

At step 210, the identification module 140 identifies a second facility having customer demographics with a pre-defined degree of similarity to customer demographics of the first facility. In one embodiment, the pre-defined degree of similarity may be that more than half of the factors match or are similar between the first facility and the second facility for a particular time period. In another embodiment, the pre-defined degree of similarity may be that all the factors match or are similar between the first facility and the second facility for a particular time period. The factors may include, but are not limited to, customer demographics, store demographics, transaction data and product information. Customer demographics data may include for each customer a type of customer (e.g., individual or family customer), type of shopping instrument used by the customer (e.g., shopping cart versus shopping basket), time of day the customer shopped and the like. Store demographics data may include store general location (e.g., city versus suburbs), store format (e.g., small-format versus large-format), store size, and the like. Transaction data may include an average amount total per transaction, an average number of items per transaction, and the like. Product information data may include for each product type of product, brand of product, price of product, rate of sale of product, and the like.

In this manner, the identification module 140 selects a second facility that has a similar customer base where the transaction data at the second facility can be compared to the transaction data at the first facility to provide valuable or applicable analysis of product offerings at the first facility. Rather than selecting any facility, the identification module 140 identifies a second facility that can be used to make a useful comparison.

In an example embodiment, the identification module 140 identifies the second facility based on the transaction data of the second facility indicating a higher-sale output than the first facility or a higher profit margin than the first facility.

In an example embodiment, the second facility identified by the identification module 140 also has similar store demographics as the first facility. In an example embodiment, the second facility identified by the identification module 140 also has similar items for sale as the first facility. In yet another embodiment, the second facility identified by the identification module 140 also has similar numbers of transactions taking place as the first facility during a given period of time.

At step 212, the item analysis module 150 analyzes transaction data of the second facility with respect to the transaction data of the first facility. For example, the item analysis module 150 may compare the number of items sold for a particular product at the first facility with that of the second facility. The item analysis module 150 may also compare the price per item sold at the first facility with that of the second facility.

At step 214, the item analysis module 150 determines an improvement or change in item assortment at the first facility based on the analyzing. For example, if the first facility sold less number of items for a particular product than the second facility, then the item analysis module 150 determines if the price of the item at the first facility needs to be adjusted to match the price of the item at the second facility. If a particular product is not selling as much at the first facility, then item analysis module 150 may determine whether the brand of the product needs to be adjusted to match the brand of the product offered at the second facility.

In one embodiment, the item analysis module 150 retrieves item placement information for the first facility from the first facility databases 340, and retrieves item placement information for the second facility from the second facility databases 345. Then the item analysis module 150 analyzes the item placement information for the first facility and the second facility and determines whether an improvement or change is needed in the item placement at the first facility. This improvement or change may be determined based on the transaction data and/or item placement data of the second facility. For example, the item analysis module 150 may determine that the item should be placed near the checkout lanes based on the placement of the item at the second facility near the checkout lanes.

As another example, the item analysis module 150 may determine that a particular product is offered at the second facility but is not offered at the first facility. The item analysis module 150 may further determine that the amount of items sold for the product at the second facility meets a certain threshold. In this case, the item analysis module 150 may automatically generate orders for inventory for the particular product for the first facility based on the determined improvement or change in item assortment at the first facility. As such, the item analysis module 150 may automatically order product for the first facility if there is enough demand for it at the second facility based on the similar customer demographics.

In an example embodiment, the item analysis module 150 generates a report that includes the improvement or change determined by the analysis system 100 in item assortment at the first facility. As used herein, item assortment refers to items or products offered by a facility for sale to customers. Item assortment may also refer to placement of the item within the facility.

In a non-limiting example, the analysis system 100 described herein can be used to analyze two facilities. The two facilities may be similar in size and may have similar demographics. For example, both of the facilities being analyzed are located in small cities, and the customer base of both facilities includes customers with a variety of ages. In an example embodiment, the customer traffic information is determined by sensing the number of times the entry/exit doors at the facilities are opened. Using sales data collected at the POS systems, the analysis system 100 determines that the two facilities have sales transactions for similar items. However, the first facility is experiencing an increase customer traffic as compared to the customer traffic at the second facility. The analysis system 100 determines that the first facility is selling more of a particular set of items versus the second facility. The analysis system 100 determines the placement or display location of these items within the first facility, and determines that the location of these items can be improved in the second facility to increase sales. This recommendation is provided in an inventory report to the second facility.

FIG. 3 illustrates a network diagram depicting a system 300 for implementing the analysis system, according to an example embodiment. The system 300 can include a network 305, sensors 310, POS system(s) 320, device 325, server 330, first facility databases 340, and second facility databases 345. Each of sensors 310, POS system(s) 320, device 325, servers 330, and databases 340, 345 is in communication with the network 305.

In an example embodiment, one or more portions of network 305 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The sensors 310 may be part of exemplary sensor systems to detect customer traffic at a facility. As described above, exemplary sensor systems include, without limitation, sensors at a shopping cart corral, emissions sensors in a parking lot, weight sensors in a parking lot, acoustic sensors in a parking lot and in the facility, image capturing sensors and/or devices at floor mats, sensors to sense suspension load in vehicles, sensors to sense disruption in an air curtain at an entrance of the facility, and other sensor systems to enable detection of customer traffic in a facility.

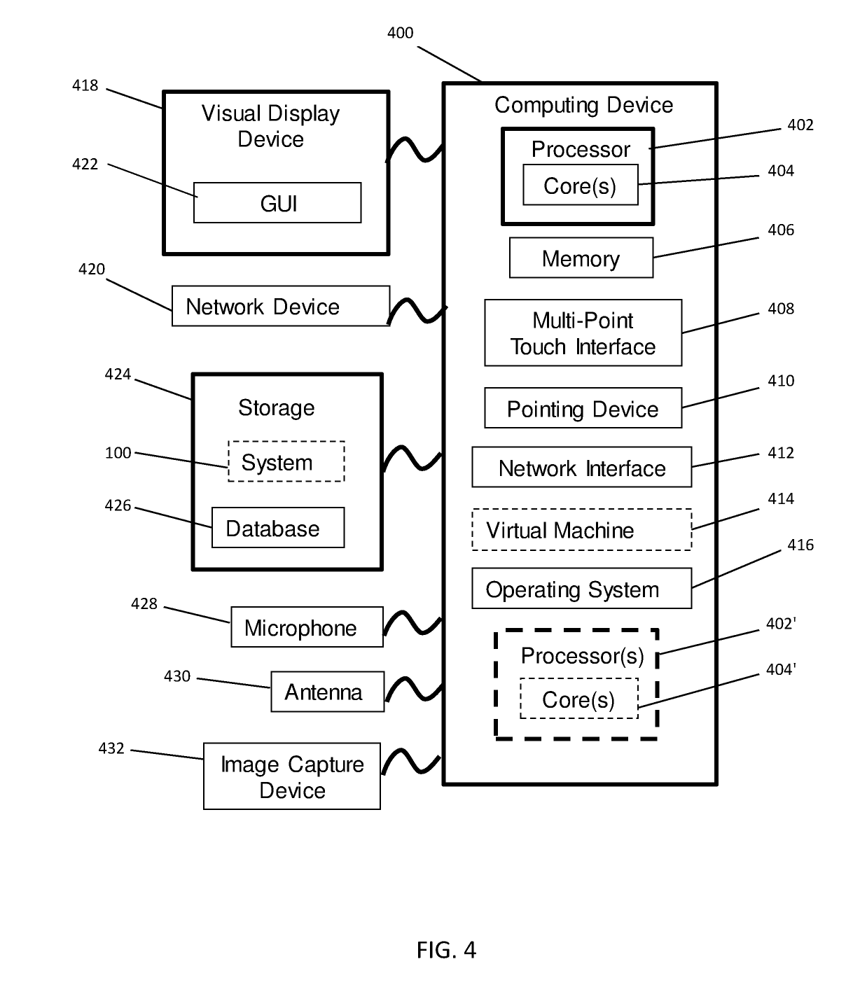

The POS system(s) 320 may include, but is not limited to, cash registers, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, network PCs, mini-computers, and the like. The POS system(s) 320 is part of a store infrastructure and aids in performing various transactions related to sales and other aspects of a store. Being part of a store's infrastructure, the POS system(s) 320 may be installed within the store or they may be installed or operational outside of the store. For example, the POS system(s) 320 may be a mobile device that a store employee can use outside of the store to perform transactions or other activities. In another example, the POS system(s) 320 may be a kiosk installed outside the store. Similarly, the POS system(s) 320 may be a mobile device that can be used within the store, and is not physically installed or attached to one particular location within the store. The POS system(s) 320 can include one or more components described in relation to computing device 400 shown in FIG. 4.

The POS system(s) 320 may also include various external or peripheral devices to aid in performing sales transactions and other duties. Examples of peripheral devices include, but are not limited to, barcode scanners, cash drawers, monitors, touch-screen monitors, clicking devices (e.g., mouse), input devices (e.g., keyboard), receipt printers, coupon printers, payment terminals, and the like. Examples of payment terminals include, but are not limited to, card readers, pin pads, signature pads, signature pens, Square™ registers, LevelUp™ platform, cash or change deposit devices, cash or change dispensing devices, coupon accepting devices, and the like.

The POS system(s) 320 may connect to network 305 via a wired or wireless connection. The POS system(s) 320 may include one or more applications or systems such as, but not limited to, a sales transaction application, and the like. One or more facilities (e.g., the first facility and the second facility) include one or more POS system(s) 320 to collect and manage transaction data at the facilities. The transaction data may be transmitted by the POS system(s) 320 to databases 340, 345.

The device 325 may include, but is not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, network PCs, mini-computers, and the like. The device 325 can include one or more components described in relation to computing device 400 shown in FIG. 4. The device 325 may connect to network 305 via a wired or wireless connection. The device 325 may be used by a user to view results of the analysis performed by the analysis system 100. The device 325 may also be used to generate inventory orders or approve inventory orders generated automatically by the analysis system 100.

Each of the database(s) 340, 345, and server 330 is connected to the network 305 via a wired connection. Alternatively, one or more of the database(s) 340, 345, and server 330 may be connected to the network 305 via a wireless connection. Server 330 may include one or more computers or processors configured to communicate with sensors 310 and/or POS system(s) 320 via network 305. Server 330 hosts one or more applications accessed by POS system(s) 320 and device 325, and/or facilitates access to the content of databases 340, 345. Server 330 may also include one or more modules of the analysis system 100. Databases 340, 345 include one or more storage devices for storing data and/or instructions (or code) for use by server 330, and/or POS system(s) 320. Databases 340, 345 and server 330 may be located at one or more geographically distributed locations from each other or from POS system(s) 320 and device 325. Alternatively, databases 340, 345 may be included within server 330.

The first facility databases 340 may be associated with the first facility, and store data related to the first facility such as the set of stored data for the first facility and the sensed data. The first facility databases 340 also stores transaction data for the first facility. The second facility databases 345 may be associated with the second facility, and store data related to the second facility such as set of stored data for the second facility, sensed data for the second facility and transaction data for the second facility.

FIG. 4 is a block diagram of an exemplary computing device 400 that can be used to perform the methods provided by exemplary embodiments. The computing device 400 includes one or more non-transitory computer-readable media for storing one or more computer-executable instructions or software for implementing exemplary embodiments. The non-transitory computer-readable media can include, but are not limited to, one or more types of hardware memory, non-transitory tangible media (for example, one or more magnetic storage disks, one or more optical disks, one or more USB flashdrives), and the like. For example, memory 406 included in the computing device 400 can store computer-readable and computer-executable instructions or software for implementing exemplary embodiments. The computing device 400 also includes processor 402 and associated core 404, and optionally, one or more additional processor(s) 402′ and associated core(s) 404′ (for example, in the case of computer systems having multiple processors/cores), for executing computer-readable and computer-executable instructions or software stored in the memory 406 and other programs for controlling system hardware. Processor 402 and processor(s) 402′ can each be a single core processor or multiple core (404 and 404′) processor.

Virtualization can be employed in the computing device 400 so that infrastructure and resources in the computing device can be shared dynamically. A virtual machine 414 can be provided to handle a process running on multiple processors so that the process appears to be using only one computing resource rather than multiple computing resources. Multiple virtual machines can also be used with one processor.

Memory 406 can include a computer system memory or random access memory, such as DRAM, SRAM, EDO RAM, and the like. Memory 406 can include other types of memory as well, or combinations thereof.

A user can interact with the computing device 400 through a visual display device 418, such as a touch screen display or computer monitor, which can display one or more user interfaces 419 that can be provided in accordance with exemplary embodiments. The visual display device 418 can also display other aspects, elements and/or information or data associated with exemplary embodiments. The computing device 400 can include other I/O devices for receiving input from a user, for example, a keyboard or another suitable multi-point touch interface 408, a pointing device 410 (e.g., a pen, stylus, mouse, or trackpad). The keyboard 408 and the pointing device 410 can be coupled to the visual display device 418. The computing device 400 can include other suitable conventional I/O peripherals.

The computing device 400 can also include one or more storage devices 424, such as a hard-drive, CD-ROM, or other computer readable media, for storing data and computer-readable instructions and/or software, such as the system 100 that implements exemplary embodiments of the analysis system described herein, or portions thereof, which can be executed to generate user interface 419 on display 418. Exemplary storage device 424 can also store one or more databases for storing suitable information required to implement exemplary embodiments. The databases can be updated by a user or automatically at a suitable time to add, delete or update one or more items in the databases. Exemplary storage device 424 can store one or more databases 426 for storing data measured by the sensors, transaction data recorded by computing systems or POS systems, customer demographics data, store demographics data, product data, inventory data, and other data/information used to implement exemplary embodiments of the systems and methods described herein.

The computing device 400 can include a network interface 412 configured to interface via one or more network devices 422 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of the above. The network interface 412 can include a built-in network adapter, network interface card, PCMCIA network card, card bus network adapter, wireless network adapter, USB network adapter, modem or another device suitable for interfacing the computing device 400 to a type of network capable of communication and performing the operations described herein. Moreover, the computing device 400 can be a computer system, such as a workstation, desktop computer, server, laptop, handheld computer, tablet computer (e.g., the iPad® tablet computer), mobile computing or communication device (e.g., the iPhone® communication device, a computing device employing the Android™ operating system), or other form of computing or telecommunications device that is capable of communication and that has sufficient processor power and memory capacity to perform the operations described herein.

The computing device 400 can run operating systems 416, such as versions of the Microsoft® Windows® operating systems, different releases of the Unix and Linux operating systems, versions of the MacOS® for Macintosh computers, embedded operating systems, real-time operating systems, open source operating systems, proprietary operating systems, operating systems for mobile computing devices, or another operating system capable of running on the computing device and performing the operations described herein. In exemplary embodiments, the operating system 416 can be run in native mode or emulated mode. In an exemplary embodiment, the operating system 416 can be run on one or more cloud machine instances.

The following description is presented to enable a person skilled in the art to create and use a computer system configuration and related method and systems for analyzing remotely located facilities. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes multiple system elements, device components or method steps, those elements, components or steps can be replaced with a single element, component or step. Likewise, a single element, component or step can be replaced with multiple elements, components or steps that serve the same purpose. Moreover, while exemplary embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods can include more or fewer steps than those illustrated in the exemplary flowcharts, and that the steps in the exemplary flowcharts can be performed in a different order than the order shown in the illustrative flowcharts.

What is claimed is:

1. A method for analyzing remotely located facilities based on sensed data, the method comprising:
sensing data by one or more sensors located at or near a first facility, the sensed data indicating customer traffic;
adding the sensed data to a set of stored data associated with the first facility;
determining customer demographics of the first facility based on the sensed data;
receiving transaction data for the first facility from one or more computing systems at the first facility;
identifying a second facility having customer demographics with a pre-defined degree of similarity to customer demographics of the first facility;
analyzing transaction data of the second facility with respect to the transaction data of the first facility; and
determining an improvement or change in item assortment at the first facility based on the analyzing.

2. The method of claim 1, further comprising:
automatically generating orders for inventory for the first facility based on the determined improvement or change in item assortment at the first facility.

3. The method of claim 1, further comprising:
retrieving item placement information for the first facility and for the second facility from a database;
analyzing the item placement information for the first facility and the second facility; and
determining an improvement or change in the item placement at the first facility based on the transaction data of the second facility.

4. The method of claim 1, wherein the customer demographics includes a classification of a customer as an individual customer or a family customer.

5. The method of claim 1, wherein the determining of customer demographics includes a using timestamp associated with the sensed data.

6. The method of claim 1, wherein the second facility identified as having customer demographics with a pre-defined degree of similarity also has at least one of similar store demographics as the first facility, has similar items for sale as the first facility, and has similar numbers of transactions taking place as the first facility.

7. The method of claim 1, wherein the one or more sensors at the first facility include foot sensors disposed at an entrance of the first facility, and the foot sensors are configured to sense a number of footsteps entering the store, wherein the number of footsteps correlates to the customer traffic at the first facility.

8. The method of claim 1, wherein the one or more sensors at the first facility include weight sensors disposed in a parking lot of the first facility, and the weight sensors are configured to sense a weight of a vehicle in the parking lot to determine a number of passengers in the vehicle, wherein the number of passengers correlates to the customer traffic at the first facility.

9. The method of claim 1, wherein the one or more sensors at the first facility include acoustic sensors disposed at a shopping cart or shopping basket, and the acoustic sensors are configured to detect sounds indicative of a number of footsteps near the shopping cart or shopping basket, wherein the number of footsteps correlates to the customer traffic at the first facility.

10. The method of claim 1, wherein the one or more sensors at the first facility are part of a sensor system, wherein the sensor system is one of a suspension load analysis system, emission sensors system, cart corral analysis system, or video analysis of floor mats.

11. A system for analyzing remotely located facilities based on sensed data, the system comprising:
one or more sensors configured to sense data indicative of customer traffic;
a processor in a processing device;
a memory in communication with the processor and storing instructions that when executed cause the processing device to:
receive sensed data from the one or more sensors located at or near a first facility, the sensed data indicating customer traffic;
add the sensed data to a set of stored data associated with the first facility;
determine customer demographics of the first facility based on the sensed data;
receive transaction data for the first facility from one or more computing systems at the first facility;
identify a second facility having customer demographics with a pre-defined degree of similarity to the customer demographics of the first facility;
analyze transaction data of the second facility with respect to the transaction data of the first facility; and
determine an improvement or change in item assortment at the first facility based on the analyzing.

12. The system of claim 11, wherein the instructions further cause the processing device to:
automatically generate orders for inventory for the first facility based on the determined improvement or change in item assortment at the first facility.

13. The system of claim 11, wherein the instructions further cause the processing device to:
retrieve item placement information for the first facility and for the second facility from a database;
analyze the item placement information for the first facility and the second facility; and
determine an improvement or change in the item placement at the first facility based on the transaction data of the second facility.

14. The system of claim 11, wherein the customer demographics includes a classification of a customer as an individual customer or a family customer.

15. The system of claim 11, wherein the determining of customer demographics includes a timestamp associated with the sensed data.

16. The system of claim 11, further comprising:
foot sensors disposed at an entrance of the first facility, wherein the foot sensors are configured to sense a number of footsteps entering the store, the number of footsteps correlating to the customer traffic at the first facility.

17. The system of claim 11, further comprising:
weight sensors disposed in a parking lot of the first facility, wherein the weight sensors are configured to sense a weight of a vehicle in the parking lot to determine a number of passengers in the vehicle, the number of passengers correlating to the customer traffic at the first facility.

18. The system of claim 11, further comprising:
acoustic sensors disposed at a shopping cart or shopping basket, wherein the acoustic sensors are configured to detect sounds indicative of a number of footsteps near the shopping cart or shopping basket, the number of footsteps correlating to the customer traffic at the first facility.

19. A non-transitory computer readable medium storing instructions that when executed by a processor causes the processor to implement a method for analyzing remotely located facilities based on sensed data, the method comprising:
sensing data by one or more sensors located at or near a first facility, the sensed data indicating customer traffic;
adding the sensed data to a set of stored data associated with the first facility;
determining customer demographics of the first facility based on the sensed data;
receiving transaction data for the first facility from one or more computing systems at the first facility;
identifying a second facility having customer demographics with a pre-defined degree of similarity to customer demographics of the first facility;
analyzing transaction data of the second facility with respect to the transaction data of the first facility; and
determining an improvement or change in item assortment at the first facility based on the analyzing.

20. The non-transitory computer readable medium of claim 18, wherein the method further comprises:
automatically generating orders for inventory for the first facility based on the determined improvement or change in item assortment at the first facility.
